(19) United States
(12) Patent Application Publication
(10) Pub. No.: US 2011/0280652 A1
(43) Pub. Date: Nov. 17, 2011

(54) STRUCTURE WITH PLURAL COMPONENTS

(75) Inventors: CHING-BAI HWANG, Tu-Cheng (TW); JIAN-ZHONG LU, Kunshan City (CN)

(73) Assignees: FOXCONN TECHNOLOGY CO., LTD., Tu-Cheng (TW); FURUI PRECISE COMPONENT (KUNSHAN) CO., LTD., KunShan City (CN)

(21) Appl. No.: 12/813,532

(22) Filed: Jun. 11, 2010

(30) Foreign Application Priority Data
May 14, 2010 (CN) 201010172861.X

(51) Int. Cl. F16B 5/02

(52) U.S. Cl. 403/332

(57) ABSTRACT

An exemplary structure includes a first body, a second body and a screw. The screw includes a head and an elongated pole extending from the head. Plural external threads are formed on the pole. The first body defines a through hole with a diameter not smaller than the major diameter of the external threads. The second body defining a latching hole comprising a first portion adjacent to the first body and a second portion farthest away the first body. Plural internal threads matching the external threads are formed on the second body around the first portion. A diameter of the second portion is larger than the major diameter of the external threads. The pole extends through the through hole and threadedly engaged with the internal threads. A free end of the pole farthest away the head is received in the second portion and apart from the second body.

### BACKGROUND

1. Technical Field

The disclosure generally relates to structures having plural components, and more particularly, relates to a structure which has plural components being mechanical connected by screws.

2. Description of Related Art

Generally, a structure is constructed of a plurality of components. Most of these components are connected together by screws, bolts, etc. However, some of the components, particularly for large-scale structures, are very thick, and is not easy to form threaded holes which extend therethrough.

What is needed, therefore, is a structure with plural components which can overcome the limitations described.

### BRIEF DESCRIPTION OF THE DRAWINGS

FIG. 1 is an isometric, exploded view of a structure in accordance with an exemplary embodiment of the disclosure.

FIG. 2 is an assembled view of FIG. 1.

FIG. 3 is similar to FIG. 1, but showing a structure according to an alternative embodiment.

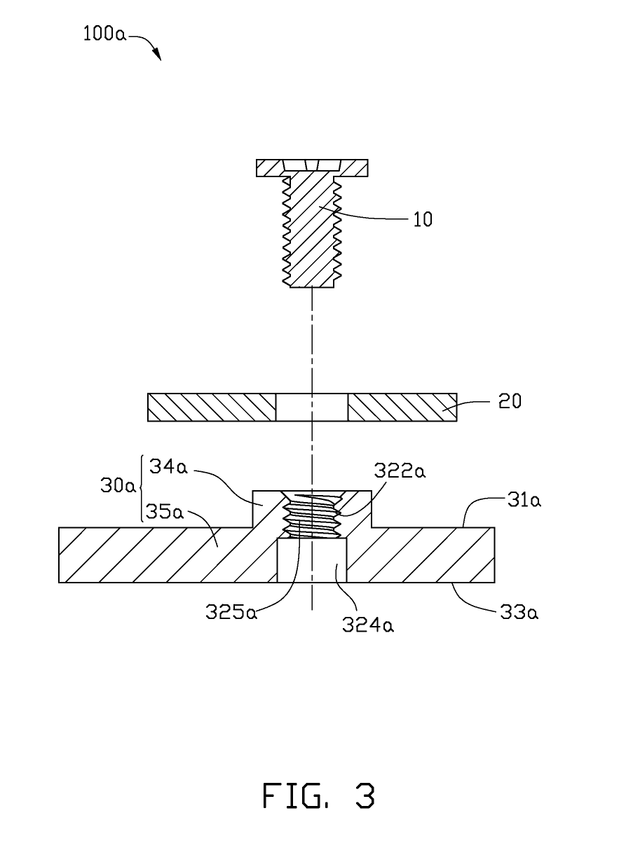

FIG. 4 is an assembled view of FIG. 3.

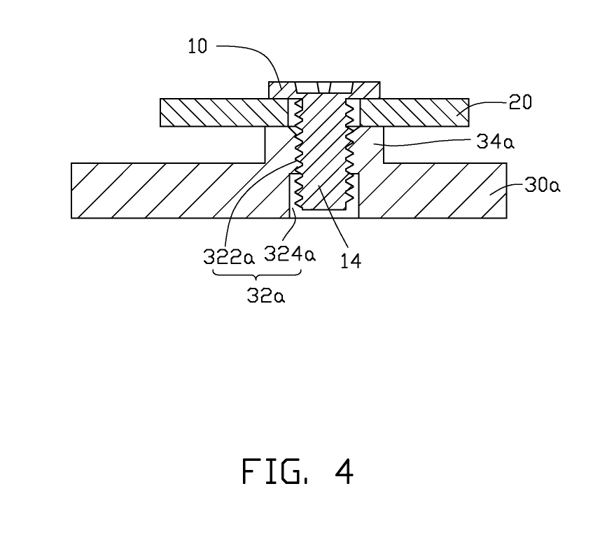

### DETAILED DESCRIPTION

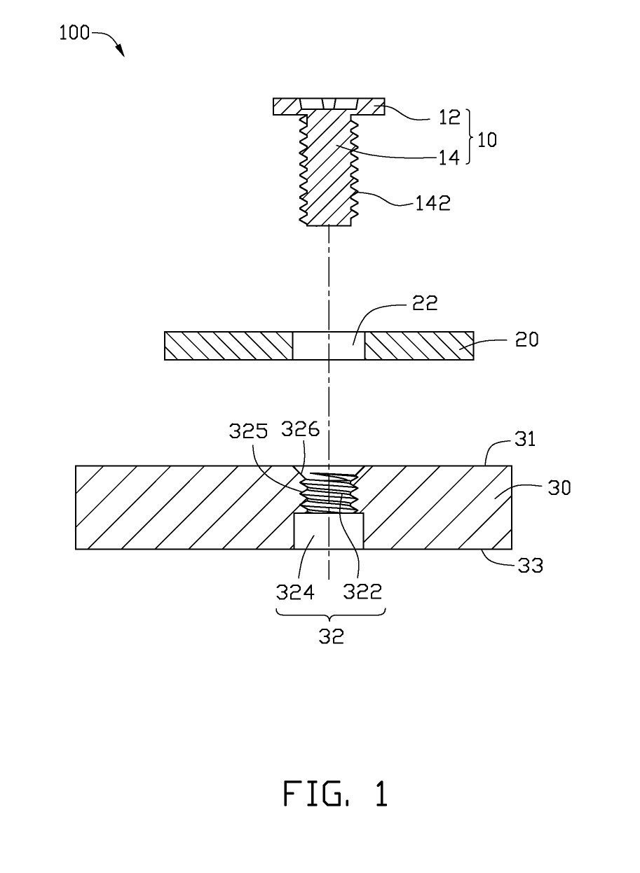

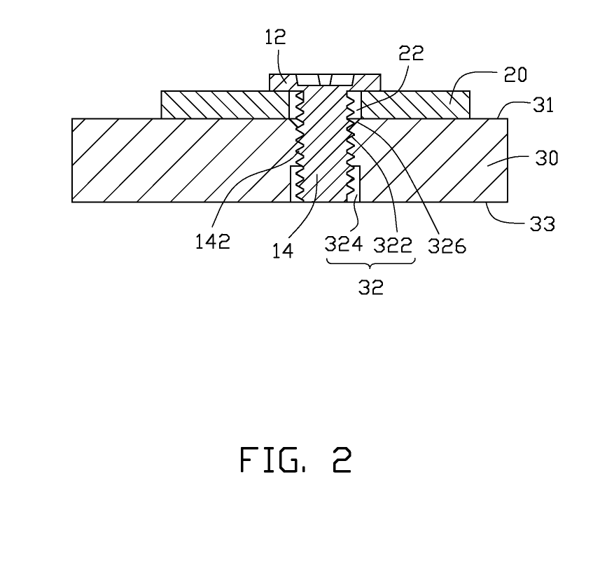

Referring to FIGS. 1 and 2, a structure 100 according to an exemplary embodiment of the disclosure is shown. For simplify the structure 100, only two components, i.e., a first body 20 and a second body 30, are shown, and detailed configurations of the first body 20 and the second body 30 are not illustrated.

As shown in FIG. 2, the first body 10 and the second body 20 are connected together by one screw 10. Alternatively, the first body 10 and the second body 20 can be connected together by plural screws 10, particularly when the first body 10 and the second body 20 are in large-scale. The screw 10 includes a head 12 and an elongated pole 14 extending perpendicularly from the head 12. The head 12 is larger than the pole 14 in diameter. A plurality of external threads 142 are formed on an outer circumferential surface of the pole 14. In this embodiment, a length of the pole 14 is substantially equal to a sum of the thicknesses of the first body 20 and the second body 30.

The first body 20 defines a through hole 22 therein for extension of the pole 14 of the screw 10 therethrough. The through hole 22 extends through the first body 20 along a thickness direction of the first body 20. The diameter of the through hole 22 is slightly larger than the major diameter of the external threads 142 of the pole 14 of the screw 10, but smaller than the diameter of the head 12 of the screw 10. An inner circumferential surface of the first body 20 around the through hole 22 is smooth. Alternatively, internal threads which match the external threads 142 of the pole 14 of the screw 10 can be formed on the inner circumferential surface of the first body 20, so as to fix the screw 10 onto the first body 20.

The second body 30 is much thicker than the first body 20. The second body 30 includes an upper face 31 and an opposite lower face 33. A latching hole 32 is defined in the second body 30 corresponding to the through hole 22 of the first body 20. The latching hole 32 extends through the second body 30 along a thickness direction thereof from the upper face 31 to the lower face 33. The latching hole 32 includes an upper portion 322 adjacent to the upper face 31, and a lower portion 324 adjacent to the lower face 33. The upper portion 322 and the lower portion 324 communicate with each other.

The upper portion 322 of the latching hole 32 has a plurality of internal threads 325 formed therearound. The internal threads 325 match the external threads 142 of the pole 14 of the screw 10. The internal threads 325 are less than the external threads 142 in number of teeth. Preferably, the number of teeth of the internal threads 325 is 3˜4. A chamfer angle 326 is defined between the upper face 31 of the second body 30 and a top end of the upper portion 322 of the latching hole 32 for facilitating inserting of the pole 14 of the screw 10 into the latching hole 32.

The lower portion 324 is coaxial with the upper portion 322 of the latching hole 32, and is larger than the upper portion 322 of the latching hole 32 in diameter. In this embodiment, a portion of an inner circumferential surface of the second body 30 around the lower portion 324 of the latching hole 32 is smooth. The diameter of the lower portion 324 of the latching hole 32 is slightly larger than the major diameter of the external threads 142.

When assembling the first body 20 to the second body 30, the first body 20 is disposed on the upper face 31 of the second body 30 with the through hole 22 and the latching hole 32 aligned with each other. The pole 14 of the screw 10 is pushed into and moves along the through hole 22 of the first body 20 to enter the top end of the upper portion 322 of the latching hole 32 of the second body 30. Then the head 12 of the screw 10 is rotated to cause the pole 14 to rotate and move along the upper portion 322 towards the lower portion 324 until the head 12 of the screw 10 encounter the first body 20. In such a state, a free end of the pole 14 farthest away the head 12 is received in the lower portion 324 of the latching hole 32 and apart from the second body 30, while other portion of the pole 14 is threadedly engaged in the upper portion 322 of the latching hole 32 to assemble the first body 20 and the second body 30 together.

Since the lower portion 324 of the latching hole 32 is formed without internal threads 325, the number of teeth of the internal threads 325 of the second body 30 is decreased. Thus, the internal threads 325 can be formed in the second body 30 easily and precisely. Accordingly, assembly of the first body 20 and the second body 30 of the structure 100 by the screw 10 is easy.

Referring to FIGS. 5 and 6, a structure 100a according to an alternative embodiment is shown. The structure 100a differs from the previous embodiment only in the second body 30a. In this embodiment, the second body 30a includes a flat plate 35a and an annular flange 34a extending up from an upper face 31a of the flat plate 35a. The latching hole 32a extends through the second body 30a from a top of the flange 34a to a bottom face 33a of the flat plate 35a. The latching hole 32a includes an upper portion 322a within the flange 34a and a lower portion 324a within the flat plate 35a. The upper portion 322a of the latching hole 32a has a plurality of internal threads 325a formed therearound which mate the external threads 142 of the pole 14 of the screw 10. The lower portion 324a of the latching hole 32a is coaxial with the upper portion 322a and is larger than the major diameter of the external threads 142. After assembled, the pole 14 of the screw 10 is threadedly engaged with the flange 34a of the second body 30a with the free end thereof received in the lower portion 324a of the latching hole 32a and spaced from the second body 30a.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A structure comprising:
a screw comprising a head and an elongated pole extending from the head, a plurality of external threads being formed on an outer circumferential surface of the pole;
a first body defining a through hole therein, a diameter of the through hole being not smaller than the major diameter of the external threads of the pole; and
a second body defining a latching hole therein corresponding to the through hole of the first body, the latching hole comprising a first portion adjacent to the first body and a second portion farthest away the first body, a plurality of internal threads matching the external threads of the pole of the screw being formed on the second body around the first portion of the latching hole, a diameter of the second portion of the latching hole being larger than the major diameter of the external threads of the pole of the screw;
wherein the pole of the screw extends through the through hole of the first body and threadedly engaged with the internal threads of the second body, a free end of the pole of the screw farthest away the head being received in the second portion of the latching hole and apart from the second body.

2. The structure of claim 1, wherein the first portion and the second portion of the latching hole are coaxial.

3. The structure of claim 1, wherein the latching hole extends through the second body along a thickness direction thereof.

4. The structure of claim 1, wherein a chamfer angle is defined in the second body at an end of the first portion of the latching hole farthest away the second portion.

5. The structure of claim 1, wherein the second body comprises a flat plate and a flange extending outwards from the flat plate, the first portion of the latching hole within the flange, and the second portion within the flat plate.

6. The structure of claim 1, wherein the second body is thicker than the first body.

7. The structure of claim 1, wherein a diameter of the head of the screw is larger than the diameter of the through hole of the first body, the head of the screw abutting against the first body.

8. A structure comprising:
a first body defining a through hole therein;
a second body defining a latching hole corresponding to the through hole, the latching hole comprising a threaded portion adjoining the first body and a smooth portion; and
a screw interconnecting the first body and the second body together, the screw comprising a pole extending through the through hole to the latching hole, the pole comprising a portion engaged in the threaded portion of the latching hole, and a portion received in the smoothed portion of the latching hole and spaced from the second body.

9. The structure of claim 8, wherein the threaded portion and the smooth portion of the latching hole are coaxial, the smooth portion being larger than the threaded portion.

10. The structure of claim 8, wherein the second body is thicker than the first body, the latching hole extending through the second body along a thickness direction thereof.

11. The structure of claim 8, wherein the second body comprises a flat plate and a flange extending outwards from the flat plate, the threaded portion of the latching hole within the flange, and the smooth portion within the flat plate.

12. The structure of claim 8, wherein the screw further comprises a head at an end of the pole, the head of the screw being larger than the through hole of the first body in diameter, and abutting against the first body.
